(19) United States
(12) Patent Application Publication
(10) Pub. No.: US 2014/0331166 A1
(43) Pub. Date: Nov. 6, 2014

(54) CUSTOMIZE SMARTPHONE'S SYSTEM-WIDE PROGRESS BAR WITH USER-SPECIFIED CONTENT

(71) Applicant: SAMSUNG ELECTRONICS CO., LTD., Suwon-si (KR)

(72) Inventor: Zhiyun LI, Kenmore, WA (US)

(73) Assignee: Samsung Electronics Co., Ltd., Suwon-si (KR)

(21) Appl. No.: 13/888,011

(22) Filed: May 6, 2013

(51) Int. Cl. G06F 3/0484

(52) U.S. Cl. CPC G06F 3/0484
USPC 715/772; 715/771

(57) ABSTRACT

An apparatus and method for customizing an Operating System (OS) function of a mobile terminal are provided. The method includes determining content data to be displayed when the OS function is called by an application running on the mobile terminal, when the OS function is called by the application, displaying the content data superimposed over the application in a display, and, when the OS function is released by the application, returning to a display of the application in the display.

### BACKGROUND OF THE INVENTION

1. Field of the Invention

The present invention relates to an apparatus and method for a mobile terminal progress bar. More particularly, the present invention relates to an apparatus and method for customizing a mobile terminal's system-wide progress bar with user-specified content.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

One feature of a mobile terminal Operating System (OS) is the display of a progress bar. The progress bar is a visual indication to the user of a time or portion of a task, such as a download or upload of a file, which is completed and a time or portion remaining. For example, if a 50 megabyte (Mb) file is being downloaded, the OS will display a rectangular bar that will change color or be filled in progressively as the file downloads. Initially the progress bar will be empty, the progress bar will indicate the download is half complete after 25 Mb of the file has been downloaded by coloring half the displayed progress bar, and the progress bar will be completely filled in when the entire file has been received. This type of progress bar fills/changes from left to right, and may also include a text statement of the progress, such as “50%” or “25 Mb of 50 Mb downloaded.”

Alternatively, if the total size of the task is unknown, a “wait” indicator can be displayed, for example, a wristwatch, a clock face with rotating hands, a rotating disc, etc. A primary difference from the progress bar described above is that the progress bar is used when a total size of the present task and the portion thereof completed is known, and the wait indicator is used when the size of the present task or portion thereof completed is not known.

FIG. 1 is a mobile terminal according to the related art.

Referring to FIG. 1, a mobile terminal 100 is in the middle of downloading the 50 Mb of the above example. A progress bar 110 is visible in the lower portion of the display 120. The progress bar 110 shows that the file is half downloaded. An application that is performing the download is visible in the display 120; the progress bar 110 is displayed superimposed over the application.

FIG. 2 is a mobile terminal according to the related art.

Referring to FIG. 2, a mobile terminal 200 is in the middle of performing a task that is not immediately completed. A wait indicator 210 is visible in the middle of the display 220, indicating to the user that the mobile terminal and the application have not crashed, but that the application is waiting for a current task to complete. The wait indicator 210 does not show progress, because it is not known to the application how long the waited-for process will take to complete, or how much of the waited-for process is complete.

The examples of FIGS. 1 and 2 are based on default indicators built into the mobile terminal Operating System (OS). For example, an application may determine during execution that a progress bar or wait indicator should be displayed, and then accesses the progress bar or wait indicator in the mobile terminal OS, if available.

Alternatively, an application may have a progress bar or wait indicator equivalent included in order to display a progress bar or wait indicator that might not be available in different OSs. For example, an application might include an animation of characters from the application to entertain the user during a wait period. However, from a perspective of programming efficiency, applications preferably rely on the indicators available within the OS, thus avoiding duplication of effort.

The above described progress bar and wait indicator of the related art OS include a predefined appearance or selection of appearances. The user is constrained to see only the information that the OS indicator is programmed to display, which may be as little information as a percentage of progress, or perhaps no more information than that a delay in response does not mean that the application or OS has crashed.

In a mobile terminal environment having limited memory and processing power available in comparison to a desktop computer, and simultaneously maintaining reception or two way communication contact with one or more of telephone base stations, WiFi base stations, BLUETOOTH connections, a Global Positioning System (GPS) satellite, etc., only a single application will be running in the foreground at any time. Thus, if the user wishes to use the delay time when a progress bar or wait indicator is invoked to switch to another application or otherwise use the mobile terminal, the progress bar or wait indicator will not be visible while the other application is running in the foreground. Thus, the user has a choice of waiting for the task to complete, or switching in and out of another application to periodically check on whether the task is completed. Both choices are inefficient and uninteresting uses of the user's time and the mobile terminal's resources and capabilities.

Accordingly, there is a need for an apparatus and method for providing a system-wide progress bar with user-specified content in a mobile terminal.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for a customized system-wide progress bar with user-specified content in a mobile terminal.

In accordance with an aspect of the present invention, a method for customizing an Operating System (OS) function of a mobile terminal is provided. The method includes determining content data to be displayed when the OS function is called by an application running on the mobile terminal, when the OS function is called by the application, displaying the content data superimposed over the application in a display, and, when the OS function is released by the application, returning to a display of the application in the display.

In accordance with another aspect of the present invention, an apparatus for displaying a customized Operating System (OS) function of a mobile terminal is provided. The apparatus includes a display screen configured to display an output of the mobile terminal, a memory configured to store the OS, one or more applications, and data generated by the OS or applications or received by the mobile terminal, and a controller configured to receive an OS function call from the one or more applications running on the mobile terminal, to determine content data to be displayed when the OS function is called by the application, to display the content data superimposed over the application in the display screen when the application calls the OS function, and to return to a display of the application when the application releases the OS function.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a mobile terminal according to the related art;

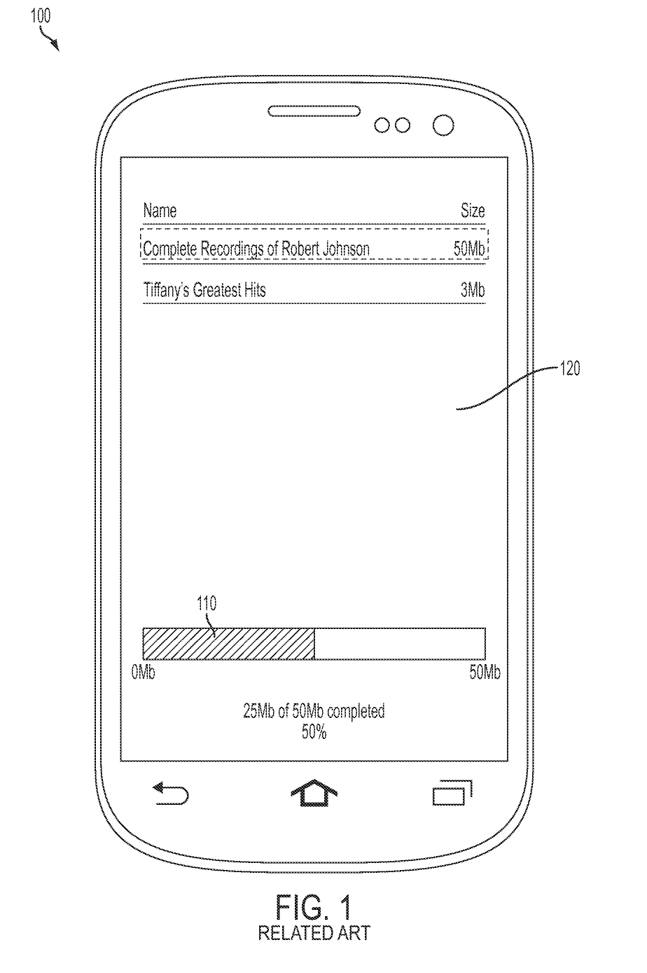

FIG. 2 is a mobile terminal according to the related art;

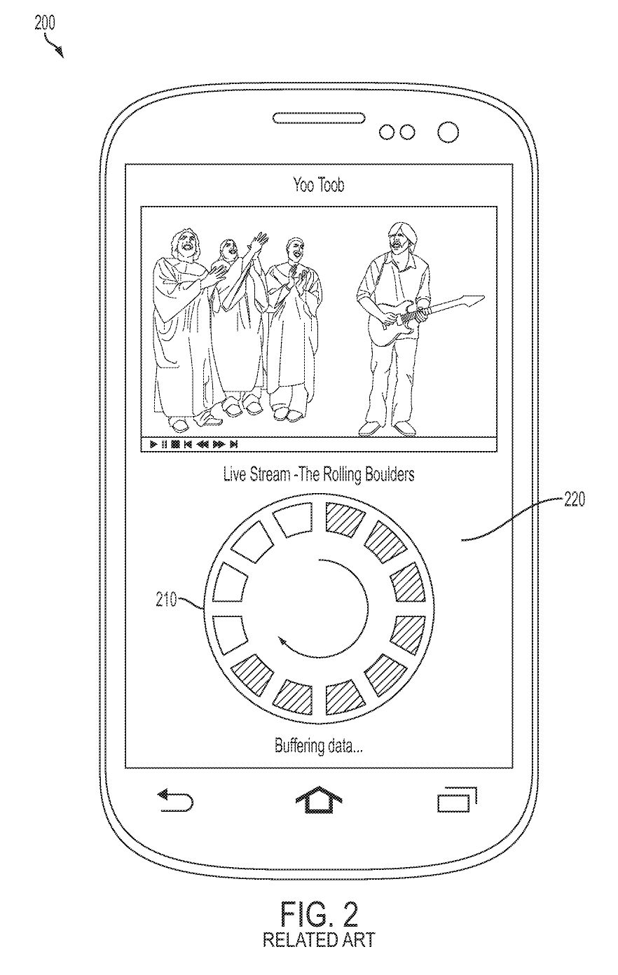

FIG. 3 is a block diagram of a mobile terminal according to an exemplary embodiment of the present invention; and

FIGS. 4A-4C illustrate a mobile terminal displaying an Operating System (OS) function according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for a customized system-wide progress bar with user-specified content in a mobile terminal.

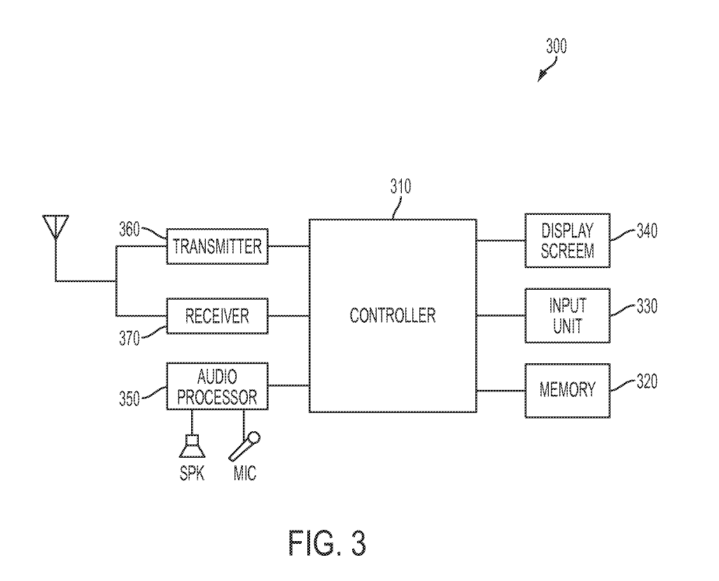

FIG. 3 is a block diagram of a mobile terminal according to an exemplary embodiment of the present invention.

Referring to FIG. 3, the mobile terminal 300 includes a controller 310, a memory 320, an input unit 330, a display screen 340, an audio processor 350, transmitter 360, and a receiver 370.

The controller 310 performs processing and control of an Operating System (OS), applications, and other functions of the mobile terminal 300. For example, the controller 310 controls to have any of the functions described herein as being performed by the controller 310.

A memory 320 provides storage for an OS, applications, and data generated or received during use of the mobile terminal 300. In particular, the memory 320 may store user-generated or user-selected content such as pictures, video recordings, etc., as well as data that is received or generated during use, for example, information on news subjects that the user has configured an application to follow. A function included in the OS is the display of a progress bar and the display of a wait icon according to an exemplary embodiment of the present invention.

An input unit 330 will include means for a user to enter data, select applications, etc., such as hard or soft keys, tappable icons, etc. A display screen 340 provides visual output for the user. Aspects of the input unit 330 and the display screen 340 may be combined in the form of a touch screen, although such is not required.

An audio processor 350 will receive an encoded audio signal from the controller 310 and put out an audio signal to a speaker SPK, and will also receive an audio signal from a microphone MIC and put out an encoded audio signal to the controller 310. For example, the mobile terminal 300 may include a wireless telephone function.

A transmitter 360 will receive a signal from the controller 310, amplify and upconvert the signal, and transmit it through an antenna. A receiver 370 will receive a signal from an antenna, downconvert and amplify the signal, and provide it to the controller 310. The transmitter 360 and receiver 370 may share use of a single antenna, although such is not required.

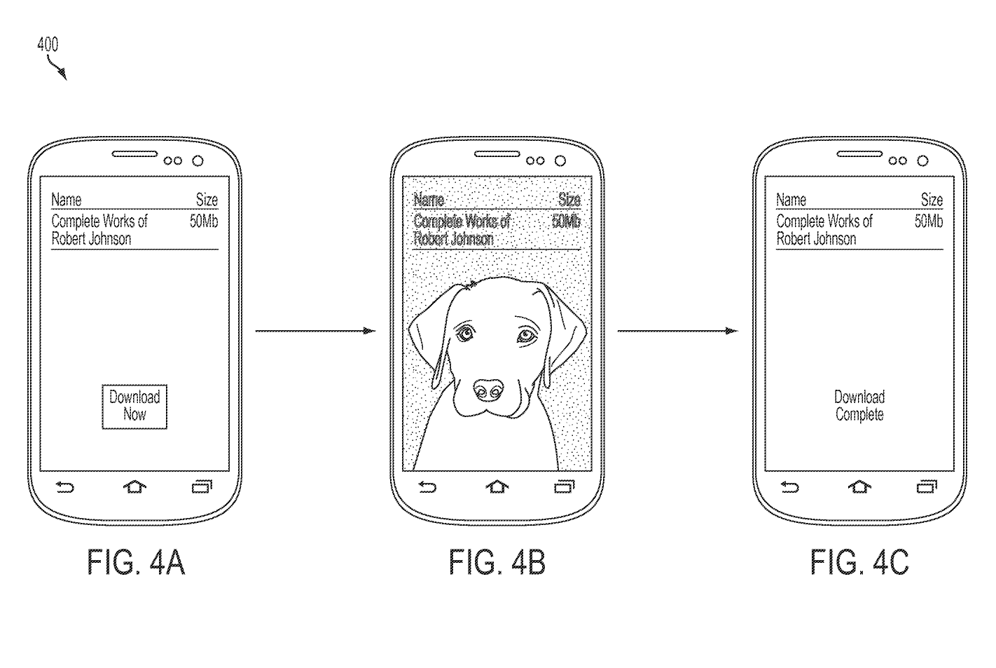

FIGS. 4A-4C illustrate a mobile terminal displaying an OS function according to exemplary embodiments of the present invention.

In FIGS. 4A-4C, the mobile terminal 400 may be implemented using the mobile terminal 300 of FIG. 3.

Referring to FIG. 4A, a user of a mobile terminal 400 has selected an operation such as a file download that cannot be immediately completed. The application determines that a progress bar will be displayed to inform the user of the download progress. The application determines to display the progress bar as soon as the application begins a lengthy operation. The progress bar will be displayed during the lengthy operation without regard to any actual estimate or expectation of a total time required for the operation to complete.

The application will then call a progress bar function from the OS. However, instead of returning a progress bar of the related art, the OS will instead display a customized progress bar function. The customized progress bar function may be set by the manufacturer or configured by the user. Further, the customized progress bar function may be predetermined or dynamically determined.

Referring to FIG. 4B, the customized progress bar function will include any content that is available for immediate display. For example, the user's photo album stored on the mobile terminal 400 may be displayed in a form of a slide show. In FIG. 4B a user's photo album is accessed by the progress bar function to display a photo of interest to the user. The displayed photo may be partially transparent as in FIG. 4B such that the user can still see the underlying application, or it may be opaque. When the task is complete, the progress bar function is released. The customized progress bar function may be configured to clear from the screen by various methods, for example, immediate removal, fading out to full transparency, swiping the photo, dissolving the photo, etc. In FIG. 4C, the application is revealed to be resumed running in the foreground after the task is completed.

The progress bar function of the OS may have multiple progress bars that can be called by applications. For example, an OS may have small, medium, and large progress bars, each of which applications may call under different circumstances according to each application's configuration. A size and a location of the called progress bar are defined in a User Interface (UI) design for each application. It is assumed that the UI design for the application has been optimized.

If the OS includes different progress bars as described above, the customized progress bars according to an exemplary embodiment of the present invention may be configured to display different content according to the progress bar called. For example, if a full screen, i.e., large, progress bar is called, the mobile terminal 400 according to an exemplary embodiment of the present invention might be configured to display large content, e.g., photos from a photo album, an email inbox with previews of new email messages, etc. If a small progress bar is called, the mobile terminal 400 might be configured to display content that is readily received in small or brief presentation, e.g., temperature, weather updates, a most recent news headline, a number indicating new email messages received, a text message received, etc.

If an application calls for a wait indicator in a case where the application cannot or does not determine a portion of a task completed and remaining, the wait indicator can also be customized according to an exemplary embodiment of the present invention. For example, an OS may have large and small circles or rotating discs to indicate an indeterminate wait time while a task completes. The wait indicators might be similarly configured to display content with brief information, for example, a weather icon, a traffic icon, etc., if a small circular wait icon is called, and to display content with more information, for example, a photo album, a recent email message, etc., if a large circular icon is called.

As described above, the progress bar according to an exemplary embodiment of the present invention has displayed content according to a predetermined configuration. However, the present invention is not limited thereto.

According to an exemplary embodiment of the present invention, the customized progress bar function may dynamically determine content to display. For example, the mobile terminal 400 might determine whether the user is indoors or outdoors. If a Global Positioning System (GPS) receiver is active but unable to detect a signal, for example, the mobile terminal 400 might determine that it is indoors and display first content, such as a most recent news headline, or a subject line or message body of a most recently received email. Alternatively, if the GPS receiver detects a signal, the mobile terminal 400 might determine that it is outdoors and display second content, such as a weather icon, current local temperature, local traffic information, etc.

If the mobile terminal 400 is configured to dynamically determine the content displayed when a progress bar or wait indicator is called, any available information or conditions, or combination of information or conditions, can be used for the dynamic determination. Examples include, but are not limited to, indoors or outdoors, a date, a time of day, a determined location, a detected light or sound, most recent updates of one or more contents of one or more types on the mobile terminal 400, a total number of updates of one or more contents of one or more types on the mobile terminal 400, a relative priority or assigned importance of contents such as a business email, a number of calendar entries, etc.

Further, content can be filtered and flagged for importance; for example, email can be filtered and flagged according to a sender, a word or phrase included in the subject line or body, etc. Thus, a business email may be given a higher priority or importance than an email from a user's spouse, and the email from the user's spouse may have a higher priority or importance than an email from the user's children, and an email with the word “EMERGENCY” or “URGENT” in the subject line may be given a higher priority or importance than any other email or content.

In an exemplary embodiment of the present invention, the progress bar function of the OS may be combined with the display of content. For example, if the slideshow of photos from the photo album are displayed when the progress bar is called by an application, a transparent or opaque progress bar may be displayed superimposed over the photos. With this exemplary embodiment the use will both be presented with interesting, new, or useful content, as well as seeing the elapsed progress of the underlying task. If the application calls the wait indicator, a transparent or opaque wait icon may be displayed superimposed over the content to indicate that an application is awaiting completion of a task.

In the above exemplary embodiments, the displayed content is displayed through a called function of the OS. In an exemplary embodiment of the present invention, a user may wish to switch applications according to the displayed content. For example, if the displayed content includes subject lines or a preview of recently received email messages, the user may determine therefrom that he wishes to switch to the email application to respond to the email. If the user wishes to switch to an application for displayed content, he may do so by selecting the displayed content, for example, by tapping an email message preview displayed on a touch screen display. In that case, the corresponding application will be launched if not previously opened, or will be moved to be the application running in the foreground if previously opened, and the application that called the progress bar or wait indicator OS function will be moved to be a background application. Thus, the user is not required to access a task manager or home screen to switch to the desired application for the content. If the user then selects the “back” option from the content application, the mobile terminal 400 will return the background application that called the OS progress bar or wait indicator function to be the application running in the foreground. If the task to be completed is complete, that is, if the application releases or has released the OS progress bar or wait indicator function, the application will open to a normal use screen, and if the task to be completed is not complete, that is, if the application has not released the OS progress bar or wait indicator function, then the customized content will be displayed according to the customized configuration.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for customizing an Operating System (OS) function of a mobile terminal, the method comprising:
determining content data to be displayed when the OS function is called by an application running on the mobile terminal;
when the OS function is called by the application, displaying the content data superimposed over the application in a display; and
when the OS function is released by the application, returning to a display of the application in the display.

2. The method of claim 1, wherein the OS function comprises one of a progress bar and a wait indicator.

3. The method of claim 2, wherein the content data is displayed concurrently with the one of the progress bar and the wait indicator.

4. The method of claim 1, wherein the OS function comprises a plurality of displays, and
wherein the content data is determined according to a display of the plurality of displays called by the application.

5. The method of claim 4, wherein the content data is predetermined according to each display of the plurality of displays.

6. The method of claim 4, wherein the content data is dynamically determined according to each of the plurality of displays.

7. The method of claim 1, wherein the content data is predetermined according to a user's selection.

8. The method of claim 1, wherein the content data comprises content data stored on the mobile terminal.

9. The method of claim 1, wherein the content data comprises one or more of a photograph, a video recording, a news headline or article, an email header item or body content, a text message, a weather icon or update, a traffic icon or update, and a calendar entry or summary.

10. The method of claim 1, wherein the content data is dynamically determined according to one or more of a current date, a current time, a detected light, a detected sound, a current location, a most recent content received, a number of contents received, and a filter or flag applied to the content data.

11. The method of claim 1, wherein the content data may be selected to switch to a corresponding application.

12. The method of claim 1, wherein the content data superimposed over the application is displayed at least partially transparent.

13. An apparatus for displaying a customized Operating System (OS) function of a mobile terminal, the apparatus comprising:
a display screen configured to display an output of the mobile terminal;
a memory configured to store the OS, one or more applications, and data generated by the OS or applications or received by the mobile terminal; and
a controller configured to receive an OS function call from an application that is running on the mobile terminal, to determine content data to be displayed when the OS function is called by the application, to display the content data superimposed over the application in the display screen when the application calls the OS function, and to return to a display of the application when the application releases the OS function.

14. The apparatus of claim 13, wherein the OS function comprises one of a progress bar and a wait indicator.

15. The apparatus of claim 14, wherein the content data is displayed concurrently with the one of the progress bar and the wait indicator.

16. The apparatus of claim 13, wherein the OS function comprises a plurality of displays, and
wherein the content data is determined according to a display of the plurality of displays called by the application.

17. The apparatus of claim 16, wherein the content data is predetermined according to each display of the plurality of displays.

18. The apparatus of claim 16, wherein the content data is dynamically determined according to each of the plurality of displays.

19. The apparatus of claim 13, wherein the content data is predetermined according to a user's selection.

20. The apparatus of claim 13, wherein the content data comprises content data stored in the memory.

21. The apparatus of claim 13, wherein the content data comprises one or more of a photograph, a video recording, a news headline or article, an email header item or body content, a text message, a weather icon or update, a traffic icon or update, and a calendar entry or summary.

22. The apparatus of claim 13, wherein the content data is dynamically determined according to one or more of a current date, a current time, a detected light, a detected sound, a current location, a most recent content received, a number of contents received, and a filter or flag applied to the content data.

23. The apparatus of claim 13, wherein the content data may be selected to switch to a corresponding application.

24. The apparatus of claim 13, wherein the content data superimposed over the application is displayed at least partially transparent.
